(19) United States
(12) Patent Application Publication
(10) Pub. No.: US 2025/0082985 A1
(43) Pub. Date: Mar. 13, 2025

(54) TREADMILL CAPABLE OF ADJUSTING RISING AND FALLING BY FOLDING BLOCK

(71) Applicant: Shenzhen Yile Dynamic Technology Co., LTD, Shenzhen (CN)

(72) Inventors: Ren LIU, Shenzhen (CN); Jinsong FAN, Shenzhen (CN)

(21) Appl. No.: 18/487,031

(22) Filed: Oct. 13, 2023

(30) Foreign Application Priority Data
Sep. 9, 2023 (CN) 202322455363.1

(51) Int. Cl. A63B 22/00; A63B 22/02

(52) U.S. Cl. CPC A63B 22/0023; A63B 22/0235

(57) ABSTRACT

Provided is a treadmill capable of adjusting rising and falling by a folding block, including: a running platform; a running frame, configured to bear the running platform; and at least one adjusting mechanism, arranged below the running frame and including a supporting frame and a folding block. The supporting frame is connected to the running frame; the folding block includes a rotating connection part rotatably connected to the supporting frame, and a supporting part fixedly connected to the rotating connection part; and the adjusting mechanism adjusts a slope of the treadmill by the folding block rotatably connected to the supporting frame.

### CROSS REFERENCE

This application claims priority benefits to Chinese Patent Application No. 202322455363.1, filed Sep. 9, 2023, the contents of which are incorporated herein by reference.

### TECHNICAL FIELD

The present invention relates to the technical field of treadmills, and in particular to a treadmill capable of adjusting rising and falling by a folding block.

### BACKGROUND

Now people are becoming more and more lazy, and sub-health is becoming more and more serious, which will seriously affect our health for a long time. In fitness exercises, running is a better way of exercise, and a treadmill is good fitness equipment to realize running indoors. Bodybuilders hope that the treadmill can simulate various road conditions, so the slope adjusting function can become the standard of most treadmills. Most of existing slope adjusting functions are driven by a motor, and the shortcomings are that the motor and the matched assemblies are high in cost, resulting in the increasing overall cost of the treadmill. In addition, since the mechanical and circuit structures of the electrical lifting structure are relatively complicated, the later maintenance and repair costs are also relatively high.

### SUMMARY

An objective of the present invention is to provide a treadmill capable of adjusting rising and falling by a folding block, thereby overcoming the shortcomings in the prior art.

To achieve the above objective, the present invention provides the following technical solution:

a treadmill capable of adjusting rising and falling by a folding block includes:
a running platform;
a running frame, configured to bear the running platform; and
at least one adjusting mechanism, arranged below the running frame and including a supporting frame and a folding block, the supporting frame being connected to the running frame, the folding block including a rotating connection part rotatably connected to the supporting frame, and a supporting part fixedly connected to the rotating connection part.

The adjusting mechanism adjusts a slope of the treadmill by the folding block rotatably connected to the supporting frame.

In one of the embodiments, the folding block is provided with a first limiting part and a second limiting part, the first limiting part being configured to limit a first endpoint in the rotating process of the folding block, and the second limiting part being configured to limit a second endpoint in the rotating process of the folding block; and

a rotatable range of the folding block is between the first endpoint and the second endpoint,

the treadmill has an adjustable maximum slope in a case that the folding block is located at the first endpoint, and

the treadmill has an adjustable maximum slope of the treadmill in a case that the folding block is located at the second endpoint.

In one of the embodiments, the first limiting part is a top of the supporting part, and through press fit between the top of the supporting part and the bottom of the running frame, limits the folding block to continue to rotate in a rotating direction.

In one of the embodiments, the first limiting part is a limiting plate arranged at the top of the supporting part, and through the press fit between one side, close to the supporting frame, of the limiting plate and one side, close to the limiting plate, of the supporting frame, limits the folding block to continue to rotate in a rotating direction.

In one of the embodiments, the second limiting part is one side, facing the bottom of the supporting frame, of the supporting part, and through the press fit between one side, facing the bottom of the supporting frame, of the supporting part and the bottom of the supporting frame, limits the folding block to continue to rotate in a rotating direction.

In one of the embodiments, a roller is arranged at a grounding end of the supporting part.

In one of the embodiments, the supporting part includes a grounding surface with a planar structure;
in a case that the grounding surface of the supporting part is in contact and parallel with a supporting surface for placing the treadmill, the treadmill is located at an adjustable maximum slope; and
in a case that a distance between one end, away from the supporting frame, of the supporting frame and the supporting surface for placing the treadmill is minimum, the treadmill is located at an adjustable minimum slope.

In one of the embodiments, in a case that the treadmill is located at the adjustable maximum slope, a position where the supporting frame is rotatably connected to the folding block is located over the grounding surface.

In one of the embodiments, the supporting frame is connected to the rotating connection part through a rotating shaft;
one end, connected to the rotating connection part, of the supporting frame is of an arc shape, and the axis of the rotating shaft coincides with the circle center of the arc shape; and
the supporting part is provided with a braking surface tangent to an arc-shaped end face of the supporting frame, and the braking surface is in interference fit with the arc-shaped end face, so that when the folding block rotates around the rotating shaft, a braking force is formed through a friction force between the braking surface and the arc-shaped end face.

In one of the embodiments, a roller is arranged at one end, away from the running frame, of the supporting frame.

In one of the embodiments, an anti-skid pad is arranged on the grounding surface of the supporting part.

In one of the embodiments, several bottom feet are arranged at the bottom of the running frame.

Compared with the prior art, the present application has the following advantages:
a slope adjusting mechanism of the present application adopts a manual mode for adjustment, and is simple in structure and relatively low in later maintenance and repair costs; secondly, compared with an electrical lifting mechanism, the manufacturing cost of the present application is also relatively low; and thirdly, the present application adopts a mechanical structure, and compared with the electrical lifting mechanism and a corresponding circuit structure, the failure rate of the present application is also relatively low.

### BRIEF DESCRIPTION OF THE DRAWINGS

The drawings of the specification that constitutes a part of the present application are used to provide a further understanding of the present invention. The exemplary embodiments of the present invention and the description thereof are used to explain the present invention, and do not constitute an improper limitation of the present invention. In the drawings:

FIG. 1 is a schematic diagram of an overall structure according to an embodiment of the present invention;

FIG. 2 is a structural schematic diagram of a first state of Embodiment 1 of the present invention;

FIG. 3 is a structural schematic diagram of a second state of Embodiment 1 of the present invention;

FIG. 4 is a structural schematic diagram of an adjusting mechanism of Embodiment 2 of the present invention;

FIG. 5 is a structural schematic diagram of a first state of Embodiment 3 of the present invention;

FIG. 6 is a structural schematic diagram of a second state of Embodiment 3 of the present invention; and

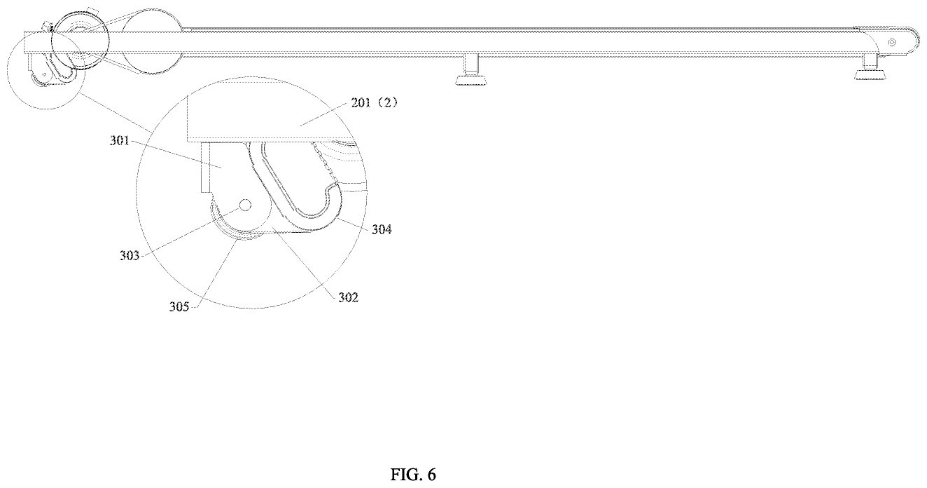

FIG. 7 is a structural schematic diagram of an adjusting mechanism of Embodiment 3 of the present invention.

Description of reference numerals: 1—running platform; 101—running belt; 102—roller; 103—running motor; 2—running frame; 201—first border; 202—second border; 203—cross frame; 3—adjusting mechanism; 301—supporting frame; 302—rotating connection part; 303—rotating shaft; 304—supporting part; 305—first limiting part; 306—second limiting part; 307—roller; 308—limiting plate; 309—braking surface; 310—anti-skid pad; 4—bottom foot.

### DETAILED DESCRIPTION OF THE EMBODIMENTS

The present invention will be described in detail below with reference to the accompanying drawings and in conjunction with embodiments. Various examples are provided by way of interpretation of the present invention and are not intended to limit the present invention. Indeed, it will be apparent to those skilled in the art that modifications and variations may be made in the present invention without departing from the scope or spirit of the present invention. For example, features shown or described as part of one embodiment may be used in another embodiment to produce yet another embodiment. Therefore, it is desirable that the present invention includes such modifications and variations falling within the scope of the appended claims and their equivalents.

In the description of the present invention, the terms “longitudinal”, “transverse”, “up”, “down”, “front”, “back”, “left”, “right”, “vertical”, “horizontal”, “top”, “bottom” and the like denote orientation or positional relationships based on those shown in the drawings and are intended for ease of description only and not to require that the present invention is necessarily constructed and operated in a particular orientation and therefore cannot be construed as limiting to the present invention. The terms “connection”, “connect” and “set” used in the present invention should be understood in a broad sense, for example, which may refer to a fixed connection or a detachable connection; which may refer to a direct connection or an indirect connection through intermediate components; which may refer to a wired electrical connection, a radio connection, or a wireless communication signal connection, and the specific meanings of the above terms may be understood by those of ordinary skill in the art according to a specific situation.

One or more examples of the present invention are shown in the accompanying drawings. The detailed description uses numeric and letter marks to refer to features in the drawings. Similar or like reference signs in the drawings and descriptions have been used to refer to similar or like parts of the present invention. As used herein, the terms “first”, “second” and “third” and the like are used interchangeably to distinguish one member from another and are not intended to denote the location or importance of individual members.

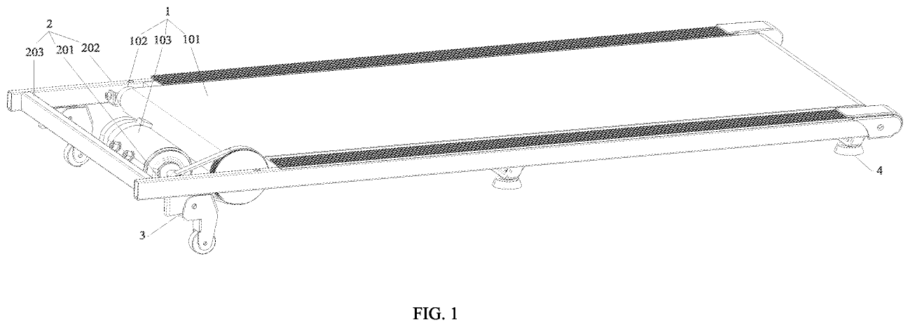

As shown in FIG. 1, according to the embodiments of the present invention, a treadmill capable of adjusting rising and falling by a folding block is provided and includes a running platform 1 and a running frame 2. The running platform 1 is provided with a running belt 101, rollers 102 arranged at two ends of the running belt 101, and at least one running motor 103 for providing a driving force to at least one roller 102. The running frame 2 is a carrier of the running platform 1 and supports the running platform 1.

According to the present application, an adjusting mechanism 3 for adjusting the slope of the treadmill is arranged at the bottom of the running frame 2. In the following embodiments, the running frame 2 is arranged on a side surface of the running platform 1, and a supporting surface for placing the treadmill is the ground.

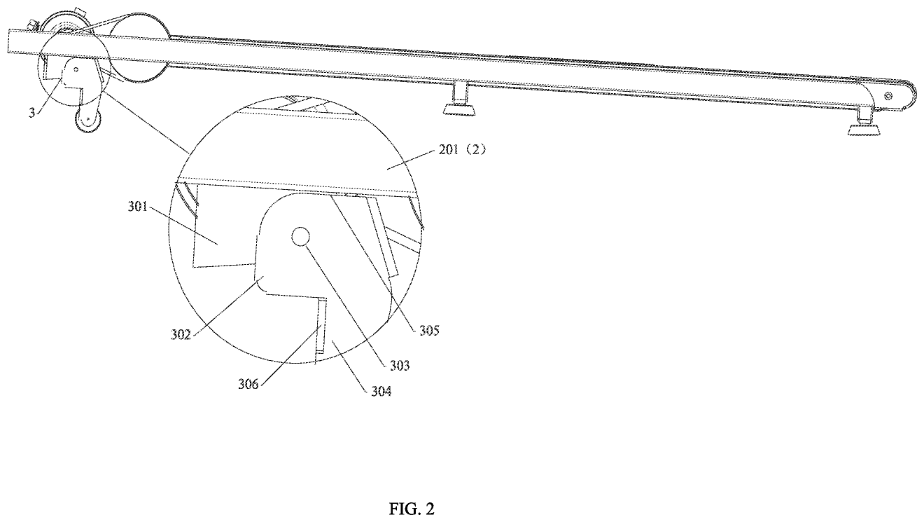

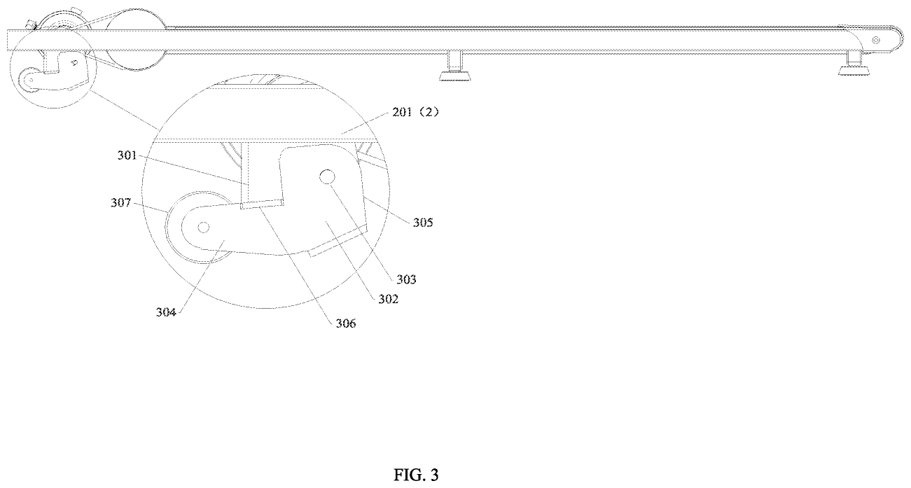

In Embodiment 1, referring to FIG. 2 and FIG. 3, at least one adjusting mechanism 3 is arranged at the bottom of one end of the running frame 2, and under normal conditions, the adjusting mechanism 3 is arranged at the tail end close to a heading direction of the running belt 101. The adjusting mechanism 3 includes a supporting frame 301, the top of the supporting frame 301 is connected to the running frame 2, and the supporting frame 301 is rotatably connected to a folding block. The folding block is provided with a rotating connection part 302, the rotating connection part 302 is connected to the supporting frame 301 through a rotating shaft 303, and the rotating connection part 302 is provided with a supporting part 304 which rotates around the rotating shaft 303. A top surface of the rotating connection part 302 is a first limiting part 305, and the first limiting part 305 is configured to limit a first endpoint in the rotating process of the folding block. A second limiting part 306 is arranged on one side, facing the bottom of the supporting frame 301, of the supporting part 304. The second limiting part 306 is configured to limit a second endpoint in the rotating process of the folding block. A rotatable range of the folding block is between the first endpoint and the second endpoint. In this embodiment, the treadmill has an adjustable maximum slope in a case that the folding block rotates to the first endpoint; and the treadmill has an adjustable minimum slope in a case that the folding block rotates to the second endpoint.

Specifically, in this embodiment, the running frame 2 includes a first border 201 and a second border 202 which are arranged on two sides of a heading direction of the running belt 101; and an adjusting mechanism 3 is arranged at the bottom of each of the first border 201 and the second border 202. Taking the first border 201 as an example, the top of the supporting frame 301 is fixedly connected to the first border 201, and the folding block is rotatably connected to the supporting frame 301 through the rotating shaft 303. When the folding block rotates to the first endpoint anticlockwise, the top surface of the rotating connection part 302 abuts against the bottom of the first border 201, and at this time, the folding block is limited to the first endpoint and cannot continue to rotate, and the treadmill is located at the adjustable maximum slope; and when the folding block rotates to the second endpoint clockwise, one side, facing the supporting frame 301, of the supporting part 304 abuts against the bottom of the supporting frame 301, and at this time, the folding block is limited at the second endpoint and cannot continue to rotate, and the treadmill is located at the adjustable minimum slope.

When the treadmill is located at the adjustable maximum slope, the top surface of the rotating connection part 302 is in face-to-face contact with the bottom surface of the first border 201, so that the treadmill is more stable during use.

To facilitate the movement of the treadmill, a roller 307 is arranged at the tail end of the supporting part 304.

In some embodiments, the adjustable maximum slope value and the adjustable minimum slope value of the treadmill are the maximum slope value or the adjacent maximum slope value, the minimum slope value or the adjacent minimum slope value which may appear in the treadmill in the rotating process of the folding block. The adjustable maximum/minimum slope value is a corresponding slope value in a stable state of the treadmill, or a corresponding slope value based on design consideration.

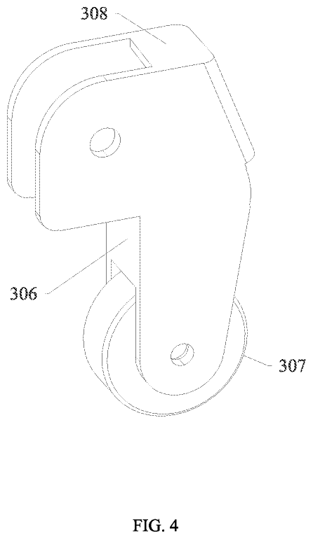

In Embodiment 2, referring to FIG. 4, based on Embodiment 1, the first limiting part 305 is a limiting plate 308 arranged at the top of the rotating connection part 302. When the folding block rotates to the first endpoint anticlockwise, one end, close to the supporting frame 301, of the limiting plate 308 abuts against the side surface of the supporting frame 301, and at this time, the folding block is limited at the first endpoint and cannot continue to rotate, and the treadmill is located at the adjustable maximum slope. In some embodiments, the second limiting part 306 and the supporting part 304 may be integrated structure design shown in this embodiment.

In Embodiment 1 and Embodiment 2, the structures and the connection relationship of the first limiting part 305 and the second limiting part 306 in the folding block depend on the technical solution, and are not limited to the technical solution for examples in the embodiments.

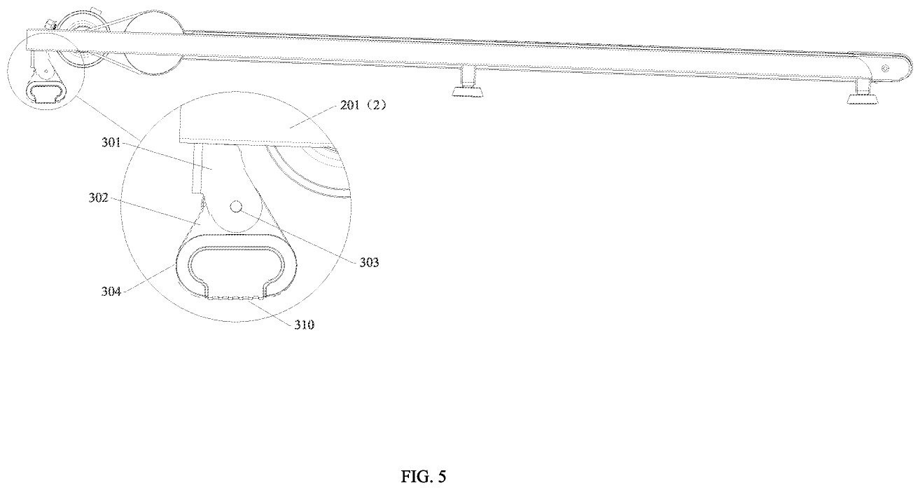

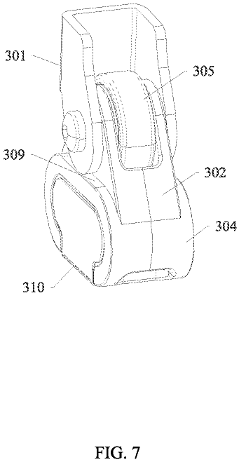

In Embodiment 3, referring to FIG. 5 and FIG. 7, at least one adjusting mechanism 3 is arranged at the bottom of one end of the running frame 2, and under normal conditions, the adjusting mechanism 3 is arranged at the tail end close to a heading direction of the running belt 101. The adjusting mechanism 3 includes a supporting frame 301, the top of the supporting frame 301 is connected to the running frame 2, and the supporting frame 301 is rotatably connected to a folding block. The folding block is provided with a rotating connection part 302, and the rotating connection part 302 is connected to the supporting frame 301 through a rotating shaft 303. One end, connected to the rotating connection part 302, of the supporting frame 301 is of an arc shape, and the rotating shaft 303 is the circle center of the arc shape. The rotating connection part 302 is of an isosceles triangle structure; the supporting part 304 is arranged at the bottom of the isosceles triangle structure of the rotating connection part 302; and a shaft hole, in shaft connection with the supporting frame 301, of the rotating connection part 302 is arranged on the apical angle bisector of the isosceles triangle structure of the rotating connection part 302. The grounding surface of the supporting part 304 is perpendicular to the apical angle bisector of the isosceles triangle structure of the rotating connection part 302. When the folding block rotates around the supporting frame 301 to the grounding surface of the supporting part 304 to be parallel with the ground, the treadmill is located at the adjustable maximum slope; and when the folding block rotates around the supporting frame 301 to one end of the arc shape of the supporting frame 301 to be in contact with the ground, the treadmill is located at the adjustable minimum slope.

Specifically, in this embodiment, the running frame 2 includes a first border 201 and a second border 202 which are arranged on two sides of a heading direction of the running belt 101; and a cross frame 203 is arranged between the first border 201 and the second border 202, and the cross frame 203 is arranged at the tail end close to the heading direction of the running belt 101. An adjustable mechanism 3 is arranged at each of two ends of the cross beam, the top of the supporting frame 301 is fixedly connected to the cross frame 203, and the folding block is in transmission connection with the supporting frame 301 through the rotating shaft 303. When the folding block rotates to the grounding surface of the supporting part 304 to be parallel with the ground, at this time, the treadmill is located at the adjustable minimum slope; and when the folding block rotates around the supporting frame 301 to one end of the arc shape of the supporting frame 301 to be in contact with the ground, the treadmill is located at the adjustable minimum slope.

Several bottom feet 4 may be arranged at the bottom of the running frame 2; and a height of each of the bottom feet 4 may be slightly greater than a height of the supporting frame 301, but less than an adjustable maximum height of the adjusting mechanism 3. The objective is that when the treadmill is located at the adjustable minimum slope, a lower end of the supporting frame 301 is not in direct contact with the ground.

To facilitate the movement of the treadmill, the supporting frame 301 is provided with a roller 307. A preferred solution is that the roller 307 and the rotating connection part 302 are coaxially mounted on the supporting frame 301. In this embodiment, when the treadmill is located at the adjustable minimum slope, optionally, the roller 307 may be in direct contact with the ground.

Since the folding block is rotatably connected to the supporting frame 301, except that the treadmill is located in a state of the adjustable maximum slope, the folding block may interfere with some operations of the treadmill without constraints. Therefore, a braking surface 309 is arranged at the top of the supporting part 304, and the braking surface 309 is in interference fit with an end face of an arc-shaped end part of the supporting frame 301. When the folding block rotates around the supporting frame 301, a braking force is formed through a friction force between the braking surface 309 of the supporting part 304 and the end face of the supporting frame 301. Under the constraint of the braking force, the folding block may maintain a relatively fixed state to avoid the above interference.

Of course, in this embodiment, the rotating connection part 302 is not limited to an isosceles triangle, a rectangle or other polygons. In the technical solution of this embodiment, the rotating shaft 303 is arranged on a perpendicular line of the grounding surface of the supporting part 304.

To improve the stability of the supporting part 304, the grounding surface of the supporting part 304 is provided with an anti-skid pad 310.

All the above embodiments are required to consider the mechanical structure relationship and analyze whether a moment under a specific structure affects the stability of the treadmill after the slope is adjusted. The structural position relationship is adjusted according to the specific slope, so that the treadmill is in the best stable state under the compliant use state.

The foregoing is merely a preferred embodiment of the present invention and is not intended to limit the present invention which may be subject to various modifications and variations to those skilled in the art. Any modification, equivalent replacement, improvement, etc. made within the spirit and principles of the present invention should be included in the protection scope of the present invention.

What is claimed is:

1. A treadmill capable of adjusting rising and falling by a folding block, comprising a running platform, and
further comprising:
a running frame, configured to bear the running platform; and
at least one adjusting mechanism, arranged below the running frame and comprising a supporting frame and a folding block, the supporting frame being connected to the running frame, the folding block comprising a rotating connection part rotatably connected to the supporting frame, and a supporting part fixedly connected to the rotating connection part,
characterized in that the adjusting mechanism adjusts a slope of the treadmill by the folding block rotatably connected to the supporting frame.

2. The treadmill according to claim 1, wherein
the folding block is provided with a first limiting part and a second limiting part, the first limiting part being configured to limit a first endpoint in a rotating process of the folding block, and the second limiting part being configured to limit a second endpoint in the rotating process of the folding block; and
a rotatable range of the folding block is between the first endpoint and the second endpoint, the treadmill has an adjustable maximum slope in a case that the folding block is located at the first endpoint, and
the treadmill has an adjustable minimum slope in a case that the folding block is located at the second endpoint.

3. The treadmill according to claim 2, wherein
the first limiting part is a top of the supporting part, and through press fit between the top of the supporting part and the bottom of the running frame, limits the folding block to continue to rotate in a rotating direction; or/and
the first limiting part is a limiting plate arranged at the top of the supporting part, and through the press fit between one side, close to the supporting frame, of the limiting plate and one side, close to the limiting plate, of the supporting frame, limits the folding block to continue to rotate in a rotating direction; or/and
the second limiting part is one side, facing the bottom of the supporting frame, of the supporting part, and through the press fit between one side, facing the bottom of the supporting frame, of the supporting part and the bottom of the supporting frame, limits the folding block to continue to rotate in a rotating direction.

4. The treadmill according to claim 2, wherein
a roller is arranged at a grounding end of the supporting part.

5. The treadmill according to claim 1, wherein
the supporting part comprises a grounding surface with a planar structure;
in a case that the grounding surface of the supporting part is in contact and parallel with a supporting surface for placing the treadmill, the treadmill is located at an adjustable maximum slope; and
in a case that a distance between one end, away from the running frame, of the supporting frame and the supporting surface for placing the treadmill is minimum, the treadmill is located at an adjustable minimum slope.

6. The treadmill according to claim 5, wherein
in a case that the treadmill is located at the adjustable maximum slope, a position where the supporting frame is rotatably connected to the folding block is located over the grounding surface.

7. The treadmill according to claim 5, wherein
the supporting frame is connected to the rotating connection part through a rotating shaft;
one end, connected to the rotating connection part, of the supporting frame is of an arc shape, and the axis of the rotating shaft coincides with the circle center of the arc shape; and
the supporting part is provided with a braking surface tangent to an arc-shaped end face of the supporting frame, and the braking surface is in interference fit with the arc-shaped end face, so that when the folding block rotates around the rotating shaft, a braking force is formed through a friction force between the braking surface and the arc-shaped end face.

8. The treadmill according to claim 5, wherein
a roller is arranged at one end, away from the running frame, of the supporting part.

9. The treadmill according to claim 5, wherein
an anti-skid pad is arranged on the grounding surface of the supporting part.

10. The treadmill according to claim 1, wherein
several bottom feet are arranged at the bottom of the running frame.
